(19) United States
(12) Patent Application Publication
(10) Pub. No.: US 2026/0046678 A1
(43) Pub. Date: Feb. 12, 2026

(54) QUALITY OF SERVICE CONTROL IN A WIRELESS COMMUNICATIONS NETWORK

(71) Applicant: LENOVO (SINGAPORE) PTE. LTD., Singapore (SG)

(72) Inventors: Dimitrios KARAMPATSIS, Ruislip (GB); Razvan-Andrei STOICA, Essen (DE); Joachim LÖHR, Wiesbaden (DE); Prateek BASU MALLICK, Dreieich (DE)

(21) Appl. No.: 19/100,686

(22) PCT Filed: Sep. 14, 2022
(86) PCT No.: PCT/EP2022/075483

§ 371 Date: Feb. 3, 2025

(30) Foreign Application Priority Data
Aug. 4, 2022 (GR) 20220100641

(51) Int. Cl. H04W 28/02

(52) U.S. Cl. CPC H04W 28/0268

(57) ABSTRACT

There is provided a wireless communication device comprising a receiver and a processor. The receiver is arranged to receive a downlink packet from an end-point address, the downlink packet marked with a reflective Quality of Service indication and packet set information. The processor is arranged to determine that reflective Quality of Service must be applied for packets sent in the uplink direction towards the end-point address and that are part of a particular packet set. The processor is further arranged to derive uplink Quality of Service rules for packet data units of the particular packet set. The processor is further arranged to determine which packets sent in the uplink direction towards the end-point address are part of the particular packet set. The processor is further arranged to apply the uplink Quality of Service rules for packets sent in the uplink direction towards the end-point address that are part of the particular packet set.

### FIELD

The subject matter disclosed herein relates generally to the field of implementing Quality of Service control in a wireless communications network. This document defines a wireless communication device, a method in a wireless communication device, a wireless communication network, a method in a wireless communication network, a first network function, a method in a first network function, a third network function, and a method in a third network function.

### BACKGROUND

Enhancements to support XR (extended reality) media may be applied within a 3GPP core network. Such an enhancement may comprise allowing the 3GPP core network to guarantee delivery of media packets that are important at the application level for recovering the media traffic even when the media packet is sent via a best effort bearer.

A PDU-set is defined in in 3GPP TR 23.700-60 v0.3.0. For the PDU-set, specific Quality of Service (QoS) requirements are defined that are either pre-configured in the 3GPP core network or provided by an Application Function (AF). The QoS requirements for the PDU-set may be defined as: PDU Set Delay Budget (PSDB) and/or PDU Set Error Rate (PSER).

### SUMMARY

Implementation of uplink QoS rules is not defined. One option would be to have the UE receive UL QoS rules from the AMF via NAS signaling; the UL QoS rule containing information of the QoS flow required for the packets of a PDU-set. In contrast to such an option, the solution presented herein allows the UE to determine to enable PDU-set marking in the UL based on reflective QoS control information. This is done without the UE receiving UL QoS rules from the AMF via NAS signaling. The described arrangements thus tend to provide QoS control on a per PDU-set basis in the uplink direction with minimal signaling overhead.

Disclosed herein are procedures for Quality of Service control in a wireless communications network. Said procedures may be implemented by a wireless communication device, a method in a wireless communication device, a wireless communication network, a method in a wireless communication network, a first network function, a method in a first network function, a third network function, and a method in a third network function.

Accordingly, there is provided a wireless communication device comprising a receiver and a processor. The receiver is arranged to receive a downlink packet from an end-point address, the downlink packet marked with a reflective Quality of Service indication and packet set information. The processor is arranged to determine that reflective Quality of Service must be applied for packets sent in the uplink direction towards the end-point address and that are part of a particular packet set. The processor is further arranged to derive uplink Quality of Service rules for packet data units of the particular packet set. The processor is further arranged to determine which packets sent in the uplink direction towards the end-point address are part of the particular packet set. The processor is further arranged to apply the uplink Quality of Service rules for packets sent in the uplink direction towards the end-point address that are part of the particular packet set.

There is further provided a method in a wireless communication device. The method comprises receiving a downlink packet from an end-point address, the downlink packet marked with a reflective Quality of Service indication and packet set 20) information. The method further comprises determining that reflective Quality of Service must be applied for packets sent in the uplink direction towards the end-point address and that are part of a particular packet set. The method further comprises deriving uplink Quality of Service rules for packet data units of the particular packet set. The method further comprises determining which packets sent in the uplink direction towards the end-point address are part of the particular packet set. The method further comprises applying the uplink Quality of Service rules for packets sent in the uplink direction towards the end-point address that are part of the particular packet set.

There is further provided a wireless communication network comprising a receiver, a processor and a transmitter. The receiver is arranged to receive a packet from a first network function and over a user plane wherein the received packet includes header information that includes a reflective Quality of Service indicator and packet set information indicating a particular packet set. The processor is arranged to determine that a wireless communication device should use reflective Quality of Service only for packets of the particular packet set. The transmitter is arranged to transmit an Access Stratum message to the wireless communication device wherein the Access Stratum message includes the packet set information and the reflective Quality of Service indicator.

There is further provided a method in a wireless communication network. The method comprises receiving a packet from a first network function and over a user plane wherein the received packet includes header information that includes a reflective Quality of Service indicator and packet set information indicating a particular packet set. The method further comprises determining that a wireless communication device should use reflective Quality of Service only for packets of the particular packet set. The method further comprises transmitting an Access Stratum message to the wireless communication device wherein the Access Stratum message includes the packet set information and the reflective Quality of Service indicator.

There is further provided a first network function comprising a processor arranged to: determine, based on packet-set requirements for an application received from an application function, whether reflective Quality of Service should apply for a packet-set carrying traffic to and/or from the application; construct a policy rule and sending the policy rule to a second network function; and provide instructions to enable reflective Quality of Service for the packet-set.

There is further still provided a method in a first network function. The method comprises determining, based on packet-set requirements for an application received from an application function, whether reflective Quality of Service should apply for a packet-set carrying traffic to and/or from the application. The method further comprises constructing a policy rule and sending the policy rule to a second network function; and providing instructions to enable reflective Quality of Service for the packet-set.

There is further provided a third network function comprising a receiver and a processor. The receiver is arranged to receive configuration information from a second network function, the configuration information indicating that reflective Quality of Service control should be applied for packets of a packet set. The processor is arranged to determine whether a packet received in a downlink belongs to the packet set; and to route packets belonging to the packet over the user plane to a base station of a wireless communication network wherein the routed packets of the packet set include a reflective Quality of Service indication and packet set information.

There is further provided a method in a third network function. The method comprises receiving configuration information from a second network function, the configuration information indicating that reflective Quality of Service control should be applied for packets of a packet set. The method further comprises determining whether a packet received in a downlink belongs to the packet set. The method further comprises routing packets belonging to the packet over the user plane to a base station of a wireless communication network wherein the routed packets of the packet set include a reflective Quality of Service indication and packet set information.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for Quality of Service control in a wireless communications network will now be described, by way of example only, with reference to the accompanying drawings, in which:

FIG. 1 depicts a wireless communication system for quality of service control in a wireless communications network;

FIG. 2 depicts a user equipment apparatus that may be used for implementing the methods described herein;

FIG. 3 depicts further details of a network node that may be used for implementing the methods described herein;

FIG. 4 illustrates a method in a wireless communication device;

FIG. 5 illustrates a method in a wireless communication network;

FIG. 6 illustrates a method in a first network function;

FIG. 7 illustrates a method in a third network function;

FIG. 8 illustrates a process by which the packets belonging to a PDU-set are handled by the 3GPP core network; and

FIG. 9 illustrates a method for applying specific QoS to a particular PDU set in the uplink direction.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group 30) consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

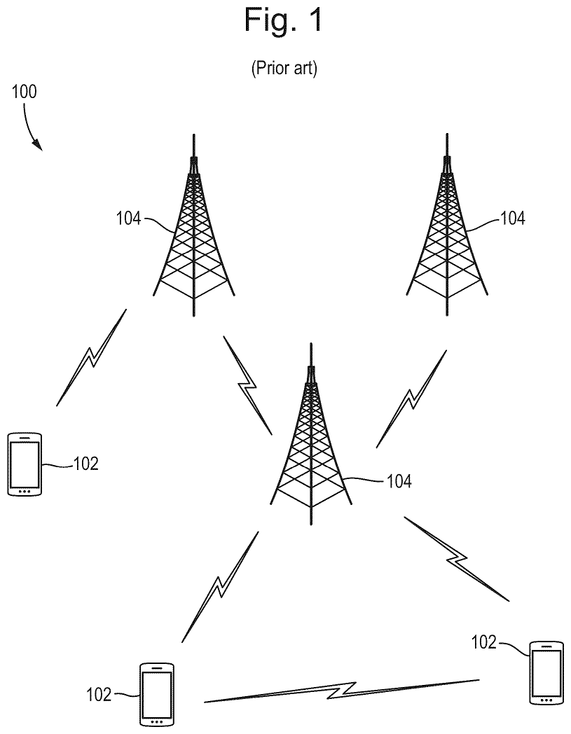

FIG. 1 depicts an embodiment of a wireless communication system 100 for Quality of Service control in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may be an implementation of a wireless communication device, a user equipment apparatus 200, or a UE 830, 930, as described herein. The base unit 104 may be an implementation of a node in a wireless communication network, a network node 300, an extended reality media (XRM) Application Function (AF) 805, 905, a policy control function (PCF) 810, 910, a session management function (SMF) 815, 915, an Access and Mobility Management Function (AMF) 820, 920, a radio access network (RAN) 825, 925, or a user plane function (UPF) 835, 935, as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

Enhancements to support XR (extended reality) media may be applied within a 3GPP core network. Such an enhancement may comprise allowing the 3GPP core network to guarantee delivery of media packets that are important at the application level for recovering the media traffic even when the media packet is sent via a best effort bearer.

A PDU-set is defined in in 3GPP TR 23.700-60 v0.3.0 as “A PDU Set is composed of one or more PDUs carrying the payload of one unit of information generated at the application level (e.g. a frame or video slice for XRM Services, as used in TR 26.926. In some implementations all PDUs in a PDU Set are needed by the application layer to use the corresponding unit of information. In other implementations, the application layer can still recover parts all or of the information unit, when some PDUs are missing.”

For the PDU-set, specific Quality of Service (QoS) requirements are defined that are either pre-configured in the 3GPP core network or provided by an Application Function (AF). The QoS requirements for the PDU-set may be defined as: PDU Set Delay Budget (PSDB) and/or PDU Set Error Rate (PSER).

PDU Set Delay Budget (PSDB) defines an upper bound for the time that a PDU-Set may be delayed between the UE and the N6 termination point at the UPF. PSDB applies to the DL PDU-Set received by the UPF over the N6 interface, and to the UL PDU-Set sent by the UE. PDU Set Error Rate (PSER) defines an upper bound for the rate of PDU-Sets (e.g. set of IP packets constituting a PDU-Set) that have been processed by the sender of a link layer protocol (e.g. RLC in RAN of a 3GPP access) but where all of the PDUs in the PDU-Set are not successfully delivered by the corresponding receiver to the upper layer (e.g. PDCP in RAN of a 3GPP access). The PSER defines an upper bound for a rate of non-congestion related packet losses

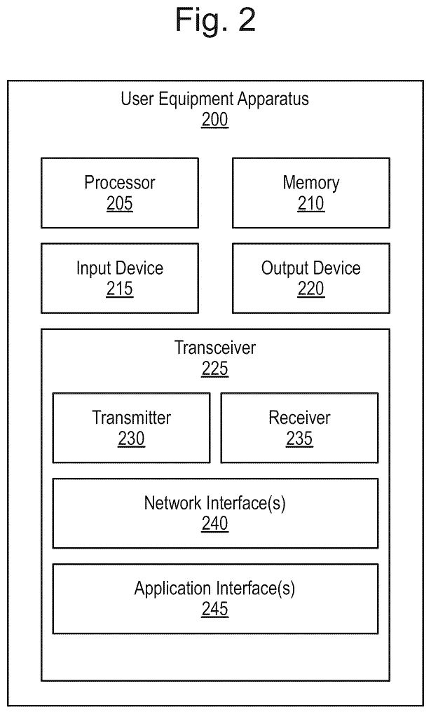

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be a wireless communication device, a remote unit 102, a user equipment apparatus 200, or a UE 830, 930 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

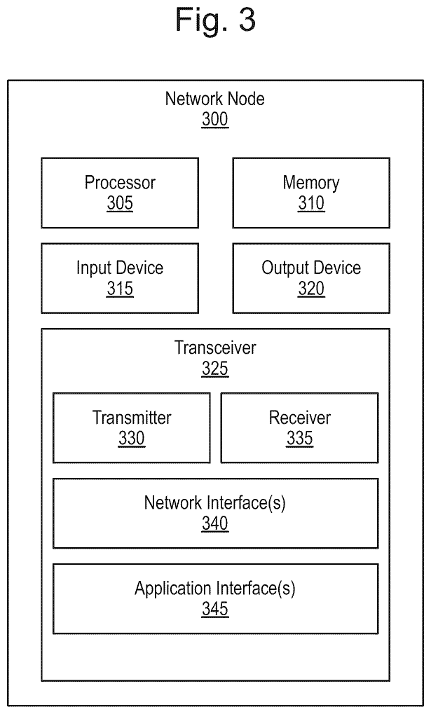

FIG. 3 depicts further details of the network node 300 that may be used for implementing the methods described herein. The network node 300 may be one implementation of a node in a wireless communication network, a base unit 104, an extended reality media (XRM) Application Function (AF) 805, 905, a policy control function (PCF) 810, 910, a session management function (SMF) 815, 915, an Access and Mobility Management Function (AMF) 820, 920, a radio access network (RAN) 825, 925, or a user plane function (UPF) 835, 935, as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Accordingly, there is provided a wireless communication device comprising a receiver and a processor. The receiver is arranged to receive a downlink packet from an end-point address, the downlink packet marked with a reflective Quality of Service indication and packet set information. The processor is arranged to determine that reflective Quality of Service must be applied for packets sent in the uplink direction towards the end-point address and that are part of a particular packet set. The processor is further arranged to derive uplink Quality of Service rules for packet data units of the particular packet set. The processor is further arranged to determine which packets sent in the uplink direction towards the end-point address are part of the particular packet set. The processor is further arranged to apply the uplink Quality of Service rules for packets sent in the uplink direction towards the end-point address that are part of the particular packet set.

The described arrangements tend to provide QoS control on a per PDU-set basis in the uplink direction with minimal signaling overhead. The wireless communication device may be a user equipment. The packet may be a packet data unit (PDU). The packet set may be a PDU set.

Based on the source address of the downlink packet the wireless communication device determines knows that any uplink packet sent towards the source address requires reflective QoS. The wireless communication device may thus determine that inspection of the packet in the uplink is needed to identify packets of a particular packet set. Further, the wireless communication device may derive uplink QoS rules for such packets. The derived uplink QoS rules may include packet set information. The packet set information may include the importance of the packet-set.

The processor may be further arranged to inspect application traffic in the uplink direction and determines packets that are part of a packet set. A packet set may comprise composed of one or more packets carrying the payload of one unit of information generated at an application level. Such an application level may comprise, for example, a frame or video slice for XRM Services.

The processor may be further arranged to request radio resources in the uplink direction according to the Quality of Service rules derived for the particular packet set.

The processor may be further arranged to determine to enable inspection of packets belonging to the particular packet set for application traffic sent in the uplink direction, the determination to enable inspection of packets based on the packet set information and the reflective Quality of Service indication.

The uplink Quality of Service rules may be derived using a packet filter corresponding to the downlink packet data unit. The packet filter may be composed of Source/Destination IP address and/or ports and IP type. The packet filter may define packets by virtue of at least one of a Source IP address, a destination IP address, a port type and/or an IP type. IP type may be, e.g. IPv4 and IPV6. When the wireless communication device receives a downlink packet from a Source IP address which is the end-point address and which is sent via a particular QoS flow with reflective QoS marking, then the wireless communication device determines that any packet sent in the uplink direction to the Source IP address will need to be sent over the same QoS flow.

The processor may be further arranged to determine reflecting Quality of Service must be applied for packets of a packet set based on the packet set information and a Reflective Quality of service Indicator received within the downlink packet. The Reflective Quality of service Indicator (RQI) may be received within header information from the downlink packet. The header information may comprise SDAP header information. The derived uplink Quality of service rules may include packet-set information received within the downlink packet. The packet set information may include importance of a packet set.

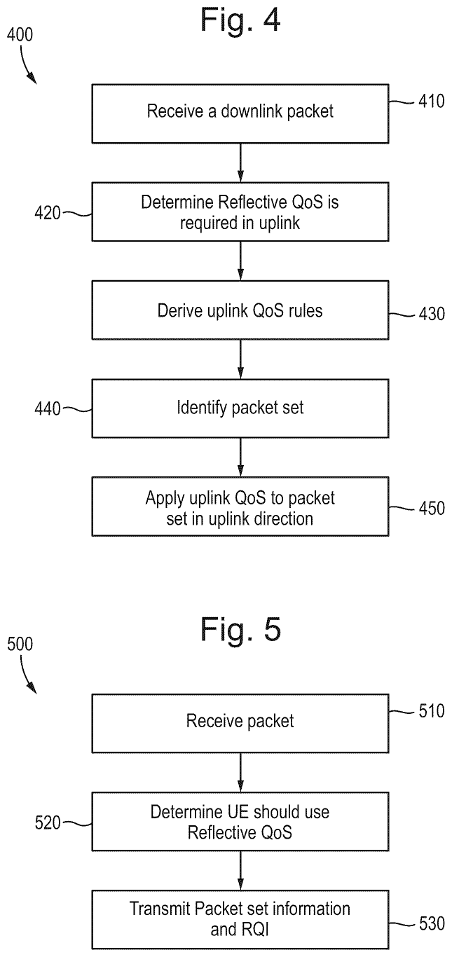

FIG. 4 illustrates a method 400 in a wireless communication device. The method 400 comprises receiving 410 a downlink packet from an end-point address, the downlink packet marked with a reflective Quality of Service indication and packet set information. The method 400 further comprises determining 420 that reflective Quality of Service must be applied for packets sent in the uplink direction towards the end-point address and that are part of a particular packet set. The method 400 further comprises deriving 430 uplink Quality of Service rules for packet data units of the particular packet set. The method 400 further comprises determining 440 which packets sent in the uplink direction towards the end-point address are part of the particular packet set. The method 400 further comprises applying 450 the uplink Quality of Service rules for packets sent in the uplink direction towards the end-point address that are part of the particular packet set.

The described arrangements tend to provide QoS control on a per PDU-set basis in the uplink direction with minimal signaling overhead. The wireless communication device may be a user equipment. The packet may be a packet data unit (PDU). The packet set may be a PDU set.

Based on the source address of the downlink packet the wireless communication device determines knows that any uplink packet sent towards the source address requires reflective QoS. The wireless communication device may thus determine that inspection of the packet in the uplink is needed to identify packets of a particular packet set. Further, the wireless communication device may derive uplink QoS rules for such packets. The derived uplink QoS rules may include packet set information. The packet set information may include the importance of the packet-set.

The method may further comprise inspecting application traffic in the uplink direction and determines packets that are part of a packet set. A packet set may be composed of one or more packets carrying the payload of one unit of information generated at an application level. Such an application level may comprise, for example, a frame or video slice for XRM Services. The method may further comprise requesting radio resources in the uplink direction according to the Quality of Service rules derived for the particular packet set.

The method may further comprise determining to enable inspection of packets belonging to the particular packet set for application traffic sent in the uplink direction, the determination to enable inspection of packets based on the packet set information and the reflective Quality of Service indication.

The uplink Quality of Service rules may be derived using a packet filter corresponding to the downlink packet data unit. The packet filter may be composed of Source/Destination IP address and/or ports and IP type. The packet filter may define packets by virtue of at least one of a Source IP address, a destination IP address, a port type and/or an IP type. IP type may be, e.g. IPv4 and IPV6. When the wireless communication device receives a downlink packet from a Source IP address which is the end-point address and which is sent via a particular QoS flow with reflective QoS marking, then the wireless communication device determines that any packet sent in the uplink direction to the Source IP address will need to be sent over the same QoS flow.

The method may further comprise determining reflecting Quality of Service must be applied for packets of a packet set based on the packet set information and a Reflective Quality of service Indicator received within the downlink packet. The Reflective Quality of service Indicator (RQI) may be received within header information from the downlink packet. The header information may comprise SDAP header information.

The derived uplink Quality of service rules may include packet-set information received within the downlink packet. The packet set information may include importance of a packet set.

There is further provided a wireless communication network comprising a receiver, a processor and a transmitter. The receiver is arranged to receive a packet from a first network function and over a user plane wherein the received packet includes header information that includes a reflective Quality of Service indicator and packet set information indicating a particular packet set. The processor is arranged to determine that a wireless communication device should use reflective Quality of Service only for packets of the particular packet set. The transmitter is arranged to transmit an Access Stratum message to the wireless communication device wherein the Access Stratum message includes the packet set information and the reflective Quality of Service indicator.

FIG. 5 illustrates a method 500 in a wireless communication network. The method 500 comprises receiving 510 a packet from a first network function and over a user plane wherein the received packet includes header information that includes a reflective Quality of Service indicator and packet set information indicating a particular packet set. The method 500 further comprises determining 520 that a wireless communication device should use reflective Quality of Service only for packets of the particular packet set. The method 500 further comprises transmitting 530 an Access Stratum message to the wireless communication device wherein the Access Stratum message includes the packet set information and the reflective Quality of Service indicator.

The first network function may comprise a user plane function (UPF). The packet set information and Reflective Quality of service Indicator may be received within header information of the received packet. The header information may comprise SDAP header information.

There is further provided a first network function comprising a processor arranged to: determine, based on packet-set requirements for an application received from an application function, whether reflective Quality of Service should apply for a packet-set carrying traffic to and/or from the application; construct a policy rule and sending the policy rule to a second network function; and provide instructions to enable reflective Quality of Service for the packet-set.

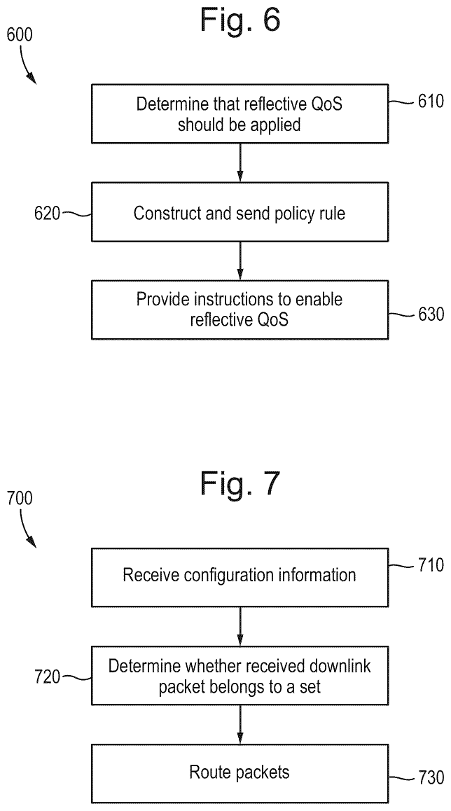

FIG. 6 illustrates a method 600 in a first network function. The method 600 comprises determining 610, based on packet-set requirements for an application received from an application function, whether reflective Quality of Service should apply for a packet-set carrying traffic to and/or from the application. The method 600 further comprises constructing 620 a policy rule and sending the policy rule to a second network function; and providing 630 instructions to enable reflective Quality of Service for the packet-set.

The first network function may comprise a Policy Control Function (PCF). The second network function may comprise a session management function (SMF). The policy rule may be a Policy and Charging Control (PCC) rule. The instructions to enable reflective Quality of Service for the packet-set may be provided to the second network function.

There is further provided a third network function comprising a receiver and a processor. The receiver is arranged to receive configuration information from a second network function, the configuration information indicating that reflective Quality of Service control should be applied for packets of a packet set. The processor is arranged to determine whether a packet received in a downlink belongs to the packet set; and to route packets belonging to the packet over the user plane to a base station of a wireless communication network wherein the routed packets of the packet set include a reflective Quality of Service indication and packet set information.

FIG. 7 illustrates a method 700 in a third network function. The method 700 comprises receiving 710 configuration information from a second network function, the configuration information indicating that reflective Quality of Service control should be applied for packets of a packet set. The method 700 further comprises determining 720 whether a packet received in a downlink belongs to the packet set. The method 700 further comprises routing 730 packets belonging to the packet over the user plane to a base station of a wireless communication network wherein the routed packets of the packet set include a reflective Quality of Service indication and packet set information.

The packet set information and Reflective Quality of service Indicator may be included within header information of the packet. The header information may comprise a GTP-U header.

The third network function may comprise a user plane function (UPF). The second network function may comprise a session management function (SMF). The packets of the packet set may be received in a downlink over an N6 reference point.

The packet set may be a PDU set. The third network function may be arranged to inspect the received packets and determine packets belonging to a packet set. Such a determination may be made by inspecting RTP packets. When the third network function detects packets of a packet set the third network function may mark the packets belonging to a packet set within a GTP-U header. The GTP-U header information may include a packet set sequence number and the size of the packet set.

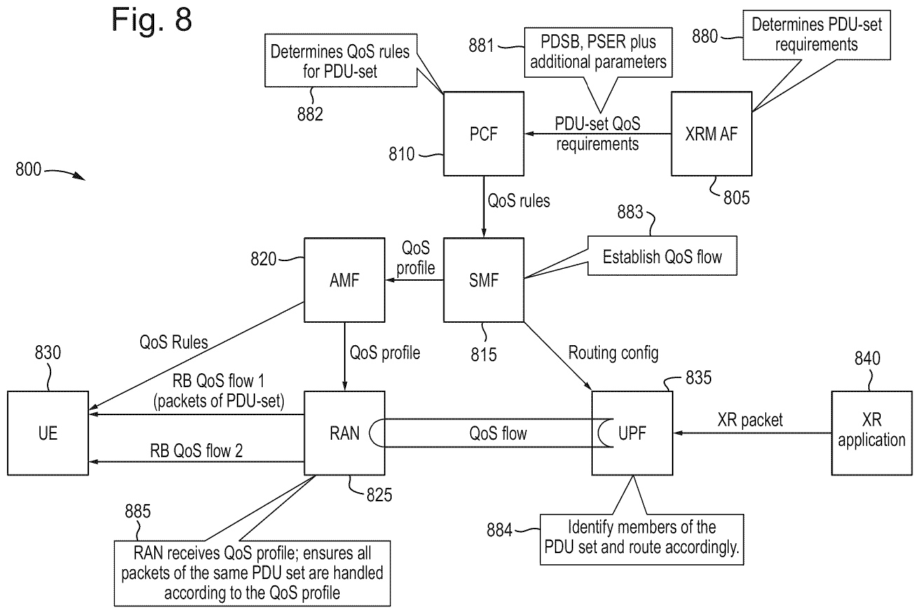

FIG. 8 illustrates a process 800 by which the packets belonging to a PDU-set are handled by the 3GPP core network. The system shown in FIG. 8 comprises an extended reality media (XRM) Application Function (AF) 805. a policy control function (PCF) 810, a session management function (SMF) 815, an Access and Mobility Management Function (AMF) 820, a radio access network (RAN) 825, a user equipment (830), a user plane function (UPF) 835, and an extended reality (XR) application 840.

The method 800 commences at 880, the XRM AF 805 determines QoS requirements for a particular PDU-set. The particular PDU-Set carries data for the XRM application 840.

At 881, where the Application Function 805 provides QoS requirements for packets of a PDU-set to the PCF 810. The QoS requirements may comprise PSDB and/or PSER. The AF 805 also sends to the PCF 810 information to identify the application. Information to identify the application may comprise a 5-tuple or application id. The AF 805 may also include an importance parameter for a PDU-set. The AF 805 may also include information for the core network to identify packets belonging to a PDU-set.

At 882, the PCF 810 derives QoS rules for the XR application 840 and specific QoS requirements for the PDU-set and configures the SMF 815. For example, a QoS rule may require the use of a 5QI for XR media traffic. The PCF 810 sends the determined QoS rules, which may include PDU-set related QoS requirements for a 5-tuple to the SMF 815. The PCF may include Policy and charging control (PCC) rules, the PCC rules dependent on the importance of the PDU-set. The importance of the PDU-set may be determined according to information received from the XRM AF 8050 or based on operator configuration.

At 883, the SMF 815 establishes a QoS flow according to the QoS rules received from the PCF 810. The SMF 815 configures the UPF 835 to route packets of the XR application 840 to a QoS flow and in addition enable PDU-set handling. The SMF 815 may configure the UPF 835 with N4 rules. Further, the SMF 815 provides the QoS profile containing PDU-set QoS requirements to the RAN 825 via the AMF 820. The AMF 820 sends the QoS Profile to the RAN 825 using a N2 SM container

At 884, the UPF 835 inspects the packets received from XR application 840 and determines packets belonging to the particular PDU-set. Such a determination may be made by inspecting RTP packets. When the UPF 835 detects packets belonging to the particular PDU-set, the UPF 835 marks the packets belonging to the particular PDU-set within their GTP-U header. The GTP-U header information includes a PDU-set sequence number and the size of the PDU set. The UPF 835 may also determine the importance of the PDU-set either based on UPF implementation means, information provided by the XRM AF 805, or information provided as metadata from an application server. Based on the importance of the PDU-set the UPF 835 may route the traffic to a corresponding QoS flow and/or include the importance of the PDU-set within a GTP-U header. The UPF 835 routes the application traffic to the corresponding QoS flow according to the rules received from the SMF 815. The GTP-U header within the QoS flow includes PDU set information. In summary, the UPF 835 may determine a PDU set from XR packets and routes packets to a corresponding QoS flow according to N4 rules received from the SMF 815.

At 885, the RAN 825 identifies packets belonging to a PDU-set (based on the GTP-U marking) and handles the packets of the PDU-set according to the QoS requirements of the PDU-set provided by the SMF 815 (via the AMF 820). The RAN 825 may receive QoS Flow Identifier (QFI) and a QoS profile of the QoS flow from the SMF 815 (via the AMF 820). Such information may be received during PDU session establishment and/or PDU session modification. The information may include PDSB and/or PSER. The RAN 825 inspects GTP-U headers and ensures all packets of the same PDU set are handled according to the QoS profile.

Further, the AMF 820 sends QoS rules to the UE 830 in an N1 SM container. The RAN 825 may establish over the Uu interface a radio bearer for a first QoS flow containing packets of the PDU-set. The RAN 825 may establish over the Uu interface a radio bearer for a second QoS flow containing packets not belonging to PDU-set.

FIG. 8 thus illustrates the case of downlink traffic i.e. traffic sent from the application server/CDN to the UE via the 3GPP core network.

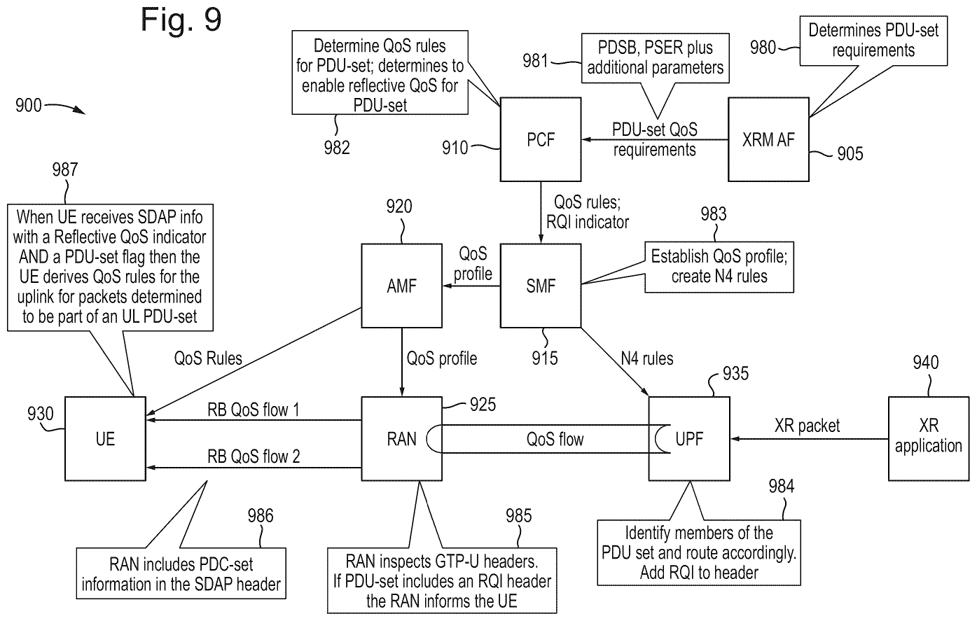

FIG. 9 illustrates a method 900 for applying specific QoS to a particular PDU set in the uplink direction. Indicating to the UE how to apply specific QoS treatment for packets belonging to a PDU-set is done by enhancing the reflective Qos procedure.

Reflective QoS is defined in 3GPP TS 23.501 v17.5.0. A PCF may enable reflective QoS for a specific QoS flow within the QoS rules provided to an SMF. The SMF configures a UPF to apply reflective QoS for the QoS flow and marks the packet within a GTP-U header with a Reflective QoS Indicator (RQI) indication. When the RAN identifies packets with RQI indication the RAN indicates the UE is to apply reflective QoS within Service Data Adaptation Protocol (SDAP) information provided to the UE via RRC signaling. When the UE receives the SDAP information with an RQI indication the UE derives a QoS rule for the uplink traffic based on the received DL traffic as described in 3GPP TS 23.501 v17.5.0 clause 5.7.5.

The solution presented in FIG. 9 defines how a network enables reflective QoS control only for packets belonging to a PDU-set. Further, it defines how a UE determines to derive QoS rule for uplink packets belonging to a PDU-set.

The system shown in FIG. 9 comprises an extended reality media (XRM) Application Function (AF) 905. a policy control function (PCF) 910, a session management function (SMF) 915, an Access and Mobility Management Function (AMF) 920, a radio access network (RAN) 925, a user equipment (930), a user plane function (UPF) 935, and an extended reality (XR) application 940.

The method 900 commences at 980, the XRM AF 905 determines QoS requirements for a particular PDU-set. The particular PDU-Set carries data for the XRM application 940.

At 981, the XRM Application Function 905 provides QoS requirements for packets of a PDU-set to the PCF 910. The QoS requirements may comprise PSDB and/or PSER. The AF 905 also sends to the PCF 910 information to identify the application. Information to identify the application may comprise a 5-tuple or application id.

At 982, The PCF 910 determines QoS rules for the XR application 940 and specific QoS requirements for the PDU-set. For example, a QoS rule may require the use of a 5QI for XR media traffic. The PCF 910 sends the determined QoS rules, which may include PDU-set related QoS requirements for a 5-tuple to the SMF 915. The PCF 910 determines to apply reflective QoS for the packets belonging to a PDU-set. The PCF 910 may determine to enable reflective QoS based on the characteristics of the XR application 940. For example, a characteristic of the XR application 940 may be that it requires the same latency (PDB, PSDB, PSER) for both downlink and uplink flows.

The PCF 910 may determine to apply reflective QoS control only for the packets of PDU-set(s) or may decide to enable reflective QoS control for all packets sent via a QoS flow (for the case where a QoS flow is established only for packets of PDU-set(s)) or may enable reflective QoS control for all packets of the XR application 940. The decision is based on network operator configuration.

In one embodiment the PCF may apply reflective QoS on per PDU-set importance level, i.e. apply reflective QoS only on highest priority PDU-set. The PCF 910 enables reflective QoS based on an indication by the UE 930 in the PDU session establishment request that reflective QoS is supported. The PCF 910 may provide PCC rules to the SMF 915. The PCC rules may include information to enable PDU-set marking and apply reflective QoS for the PDU-set packets or apply reflective QoS for the QoS flow where PDU-set packets are sent or alternatively, the PCC rule may have separate indication to enable reflective QoS control for all packets of the XR application 940.

At 983, the SMF 915 establishes a QoS flow according to the QoS rules by the PCF 910 and configures the UPF 935 to route packets of the XR application 940 to a QoS flow and in addition enable PDU-set handling and reflective QoS control. In one arrangement the configuration may indicate to the UPF 935 to apply reflective QoS control only for packets of PDU-set(s) or importance of a PDU-set. In addition, the SMF 915 provides the QoS profile containing PDU-set QoS requirements to the RAN 925 via the AMF 920. The QoS profile of the QoS flow may include the PDSB and PSER information. Further, the SMF 915 may create N4 rules instructing the UPF 935 to mark RQI for the packets belonging to PDU-set.

At 984, The UPF 935 inspects the packets received from XR application 940 and determines packets belonging to a PDU-set and the importance of the PDU-set. Such a determination may be made by inspecting the RTP packets. When the UPF 935 detects packets of the particular PDU-set, the UPF 935 marks the packets belonging to the PDU-set within a GTP-U header. The UPF 935 also adds the RQI indication as a separate GTP-U header. The GTP-U header information may include a PDU-set sequence number and the size of the PDU set. In addition, the GTP-U header may include a PDU-set importance. The UPF 935 routes the packets of a PDU-set to a corresponding QoS flow according to the rules received from the SMF 915 based on PCC rules provided by the PCF 910. UPF 935 determines the PDU-set from XR packets and routes packets to a corresponding QoS flow according to the received N4 rules. The UPF 935 also adds RQI in the GTP-U header.

At 985, the RAN 925 identifies packets belonging to a PDU set and handles the packets of the PDU-set according to the QoS requirements of the PDU-set provided by the SMF 915. The RAN 925 may identify packets belonging to a PDU set based on the GTP-U marking. The RAN 925 may receive QFIs, QoS profile of QoS flow which includes PDSB and PSER from the SMF 915 (via AMF 920) and during PDU session establishment/modification. In one implementation a node of the RAN 925 may use a different radio bearer with higher QoS requirement (for example, according to the PDU-set PSDB) to guarantee delivery of the packets of the PDU-set, while use a different radio bearer according to the 5QI of the QoS flow for the non-PDU-set packets. If the packet of a PDU-set is marked also with an RQI indication the RAN determines that reflective QoS need to be applied over the radio bearer established to route packets of a PDU-set. The radio bearer to route packets of a PDU-set may be the same as the one used for the QoS flow that carries the PDU-set packets.

The RAN 925 may establish over the Uu interface a radio bearer for a first QoS flow containing packets of the PDU-set. The RAN 925 may establish over the Uu interface a radio bearer for a second QoS flow containing packets not belonging to PDU-set. Further, the AMF 920 sends QoS rules to the UE 930 in an N1 SM container. In one embodiment the node of the RAN 925 may use a different radio bearer with higher QoS requirement (according to the PDU-set PSDB/PSER) to guarantee delivery of the packets of the PDU-set, while use a different radio bearer according to the 5QI of the QoS flow for the non-PDU-set packets.

At 986, the RAN 925 includes PDU-set information in the SDAP header. The SDAP headers include: Reflective QoS flow to DRB mapping Indication; PDU-set indicator; and PDU-set importance. The reflective QoS flow to DRB mapping indication instructs the UE to map the QoS flow in the uplink DRB. The PDU-set indicator tells the UE to apply RQI only for packets within a PDU-set in the UL direction. The PDU-set importance indicates the importance of the PDU-set of packets in the UL direction that need RQI.

At 987, based on the received PDU-set information the UE 930 determines that uplink traffic must be inspected to determine packets belonging to a PDU set. In addition, the UE 930 derives UL QoS rules for UL packets of the XR application 940 (or applications) that are determined to be part of the PDU-set or part of the same importance PDU-set based on the DL packet received. The derived UL QoS rules may include: the Source and Destination Address and the packet-set information included in the downlink packet. The UE 930 inspects UL packets of the XR application and determines packets belonging to a PDU-set and their importance. The UE 930 routes the UL packets of the PDU set via the radio bearer corresponding to the derived UL QoS rule for the PDU-set.

Accordingly, there is provided a system whereby Reflective QoS control allows the network to instruct the UE to derive QoS rules for uplink flows without the need to provide QoS rule over control plane signaling.

Where the QoS architecture of a wireless communication network is to support an XR-type application where some of the packets of the XR application have higher importance than other packets, then such packets require different treatment over the network with different packet delay and error rate characteristics. 3GPP has defined the notion of a PDU-set which contains information on “higher importance” packets. The network (UPF) inspects application traffic and marks the important packet within GTP-U header. This allows the RAN to determine which packets in the downlink require different QoS over the radio network.

As described herein, Reflective QoS is utilized to allow the network operator to instruct the UE to enable PDU-set on the uplink without needing to provide any QoS rules to the UE over the control plane.

A solution presented herein uses the PCF to determine whether to enable reflective QoS for application traffic where PDU-set QoS requirements are available (either from AF or pre-configured in the PCF). The PCF then provide PCC rules to the SMF instructing the SMF to enable reflective QoS for packets belonging to PDU sets. The UPF marks the packet of a PDU-set with RQI flag and PDU-set flag. The RAN based on the PDU-set and RQI flag determines that reflective QoS is required and provides within SDAP information to enable reflective QoS control for the packet. The UE based on the PDU-set information within SDAF determines to enable PDU-set inspection and enable reflective QoS control.

The described arrangements thus tend to provide QoS control on a per PDU-set basis in the uplink direction with minimal signaling overhead. That is, in contrast to the option of the UE receiving UL QoS rules from the AMF via NAS signaling; the UL QoS rule containing information of the QoS flow required for the packets of a PDU-set. As presented herein, a UE is able to determine to enable PDU-set marking in the UL based on reflective QoS control information. This is done without the UE receiving UL QoS rules from the AMF via NAS signaling.

Accordingly, there is provided a method in a wireless communication device, the method comprising: Receiving at a user equipment a downlink packet that is marked with a reflective QoS indication and a PDU-set information; Determining that reflective QoS must be applied for the packets that are part of a PDU-set in the uplink direction; Deriving uplink QoS rules for packet data units of the PDU-set with a packet filter corresponding to the downlink packet data unit; and Applying the derived uplink QoS rules for packet data units sent in the uplink that are derived to be part of a PDU-set.

The UE may determine reflecting QoS must be applied for packets of a PDU-set based on the PDU-set information and RQI indication received within SDAP header information from the downlink packet.

The UE may inspect application traffic in the uplink and determines packets that are part of a PDU-set.

The PDU-set information may include the importance of a PDU-set.

There is further provided a method in a node of a wireless communication network, the method comprising: Receiving packets over the user plane from a first network function (such as a UPF) wherein the packet includes header information that includes an RQI and PDU-set information; Determining to transmit information to a user equipment to apply reflective QoS only for packets of PDU-set; Transmitting an Access Stratum message to a user equipment wherein the message includes SDAP information with a PDU-set information and RQI indication.

There is further still provided a method in a UPF, the method comprising: Receiving configuration information from a first network function (such as an SMF) to apply reflective QoS control for packets of a PDU-set; Determining packets of a PDU-set received in the downlink (for example, over an N6 reference point); and Routing packets over the user plane to a first RAN node wherein the packets include a GTP-U header with RQI and PDU-set information.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer

readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following acronyms are relevant in the field of the present application: UE, User Equipment; PDU-set, Packet Data Unit set; UL, Uplink; DL, Downlink; QoS, Quality of Service; XR, Extended Reality; RQI, Reflective QoS Indicator; SDAP, Service Data Adaptation Protocol; PSDB, PDU Set Delay Budget; PDB, Packet Delay Budget; and PSER, PDU Set Error Rate.

1. A user equipment (UE) for wireless communication, comprising:
at least one memory; and
at least one processor coupled with the at least one memory and configured to cause the UE to:
receive a downlink packet from an end-point address, the downlink packet marked with a reflective Quality of Service indication and packet set information;
determine that reflective Quality of Service must be applied for packets sent in an uplink direction towards the end-point address and that are part of a particular packet set;
derive uplink Quality of Service rules for packet data units of the particular packet set;
determine which packets sent in the uplink direction towards the end-point address are part of the particular packet set; and
apply the uplink Quality of Service rules for packets sent in the uplink direction towards the end-point address that are part of the particular packet set.

2. The UE of claim 1, wherein the at least one processor is further configured to cause the UE to inspect application traffic in the uplink direction and determines packets that are part of a packet set.

3. The UE of claim 1, wherein the at least one processor is further configured to cause the UE to request radio resources in the uplink direction according to the Quality of Service rules derived for the particular packet set.

4. The UE of claim 1, wherein the at least one processor is further configured to cause the UE to determine to enable inspection of packets belonging to the particular packet set for application traffic sent in the uplink direction, wherein the determination to enable inspection of packets is based on the packet set information and the reflective Quality of Service indication marking within the downlink packet.

5. The UE of claim 1, wherein the uplink Quality of Service rules are derived using a packet filter corresponding to the downlink packet data unit.

6. The UE of claim 1, wherein the derived uplink Quality of service rules include packet-set information received within the downlink packet.

7. The UE of claim 1, wherein the packet set information includes importance of a packet set.

8. A method performed by a user equipment (UE), the method comprising:
receiving a downlink packet from an end-point address, the downlink packet marked with a reflective Quality of Service indication and packet set information;
determining that reflective Quality of Service must be applied for packets sent in an uplink direction towards the end-point address and that are part of a particular packet set;
deriving uplink Quality of Service rules for packet data units of the particular packet set;
determining which packets sent in the uplink direction towards the end-point address are part of the particular packet set; and
applying the uplink Quality of Service rules for packets sent in the uplink direction towards the end-point address that are part of the particular packet set.

9. The method of claim 8, further comprising:
inspecting application traffic in the uplink direction; and
determining packets that are part of a packet set.

10. The method of claim 8, further comprising; requesting radio resources in the uplink direction according to the Quality of Service rules derived for the particular packet set.

11. The method of claim 8, further comprising: determining to enable inspection of packets belonging to the particular packet set for application traffic sent in the uplink direction, wherein the determination to enable inspection of packets based on the packet set information and the reflective Quality of Service indication.

12. The method of claim 8, wherein the uplink Quality of Service rules are derived using a packet filter corresponding to the downlink packet data unit.

13. The method of claim 8, wherein the derived uplink Quality of service rules include packet-set information received within the downlink packet.

14. The method of claim 8, wherein the packet set information includes importance of a packet set.

15. A network entity for wireless communication, comprising:
at least one memory; and
at least one processor coupled with the at least one memory and configured to cause the network entity to:
receive a packet from a first network function and over a user plane, wherein the received packet includes header information that includes a reflective Quality of Service indicator and packet set information indicating a particular packet set;
determine that a user equipment (UE) should use reflective Quality of Service only for packets of the particular packet set; and
transmit an Access Stratum message to the UE, wherein the Access Stratum message includes the packet set information and the reflective Quality of Service indicator.

16. (canceled)

17. A first network function for wireless communication, comprising:
at least one memory; and
at least one processor coupled with the at least one memory and configured to cause the network function to:
determine, based on packet-set requirements for an application received from an application function, whether reflective Quality of Service should apply for a packet-set carrying traffic to or from the application;
construct a policy rule;
send the policy rule to a second network function; and
provide instructions to enable reflective Quality of Service for the packet-set.

18. (canceled)
